(19) United States
(12) Patent Application Publication
(10) Pub. No.: US 2004/0026918 A1
(43) Pub. Date: Feb. 12, 2004

(54) Multiple tags of double thickness, printable with a thermal transfer printer for making of electro-technical and/or electronic elements

(76) Inventor: Ivana Piana, Predosa (IT)

Correspondence Address: Richard M. Goldberg, Suite 419, 25 East Salem Street, Hackensack, NJ, 07601, US

(21) Appl. No.: 10/213,591

(22) Filed: Aug. 7, 2002

(51) Int. Cl. B42D 15/00

(52) U.S. Cl. 283/81; 40/299.01

(57) ABSTRACT

Multiple tags of double thickness for marking electro technical and/or electronic elements obtained by die-cutting from a thin continuous strip (1) of calendered material so that two lateral margins (2) are obtained by this die-cutting, interconnected by opposed tags, which in turn are butted in the centre, whereas both opposed tags (3) are identically printed with the proper markings by a thermal transfer label printer and the strips (1) with the marked tags (3) are then folded to create tags of double thickness and double markings on both outer surfaces; these double thickness tags (3) will then be provided with a suitable support (6) for the identification of electric components after the tags have been removed from the superimposed margins (2) or they may be directly used on electronic components provided with their own support.

This invention covers a marking system for electronic components (cables, systems, instruments, control panels etc.). Identification and marking systems consisting of elements or multiple tags on which characters or references are printed during production or by plotter based computer software have long been known. These marking systems, if compared with the manual composition of the marking elements permit fairly quick and accurate marking even for large marking series. However, plotter printing takes a rather long time as compared with the most vanguard printers now available on the market.

According to this invention, as a variation of the above described systems where the tags are composed of individual marking elements or computerised by plotter, the marking tags are now printed with a thermal transfer label printer.

According to this invention, the tags are obtained by die-cutting of a thin calendered film folded together so as to obtain tags of double thickness which permits to handle the tags and fit them in the supports of the electronic elements to be marked; this handling would have been impossible with tags having the same thickness as the calendered film which, as said before, is indeed very thin, while on the other hand the film has to be very thin to permit the utilisation of a thermal transfer label printer.

For this reason, the calendered and die-cutting sheet consists of two comb-shaped and opposed elements interconnected by the internal butt-jointed ends of the tags. The tags of these opposed comb-shaped elements are marked by the thermal transfer label printer and the tags are then superimposed by rotation along their central jointing line so as to obtain a comb-shaped element with tags having double thickness so that they can be more easily handled and fitted in their supports or directly mounted on the cables and equipments to be identified.

It should be stressed that both parts of the tags will be printed so that the comb thus obtained may be used by holding the lateral margin indifferently with the right or left hand.

An arrow shaping may be provided in the comb zone near the folding line to ensure a more stable fitting of the tag in its support or its fastening on the cables or equipment to be identified.

The system, subject matter of this invention is illustrated in its practical and exemplified implementation in the attached drawings in which:

FIG. 1 shows a top view of calendered film after die-cutting;

FIG. 2 shows a perspective view of the die-cutting film after the markings have been printed with a thermal transfer label printer;

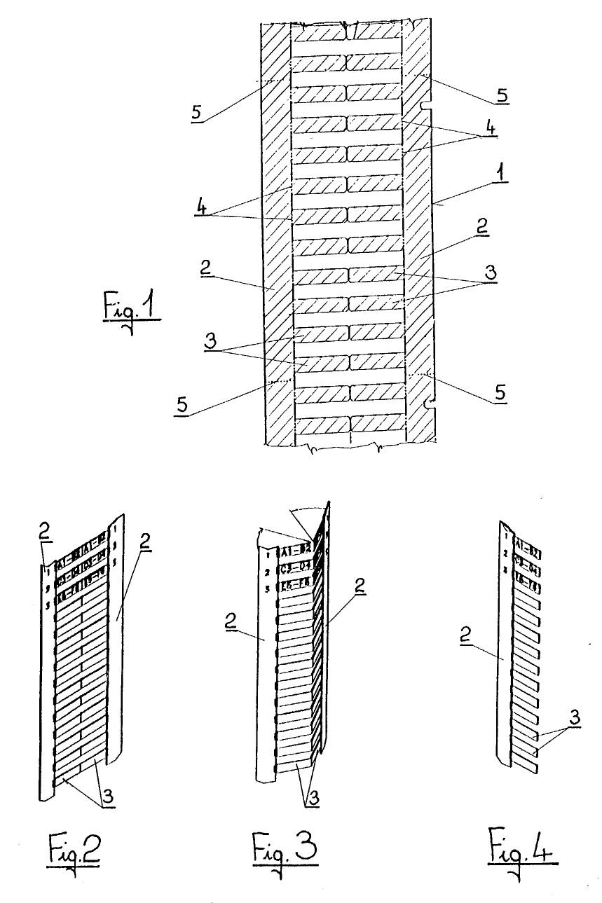

FIG. 3 shows a perspective view of the film being folded and superimposed as illustrated in FIG. 2;

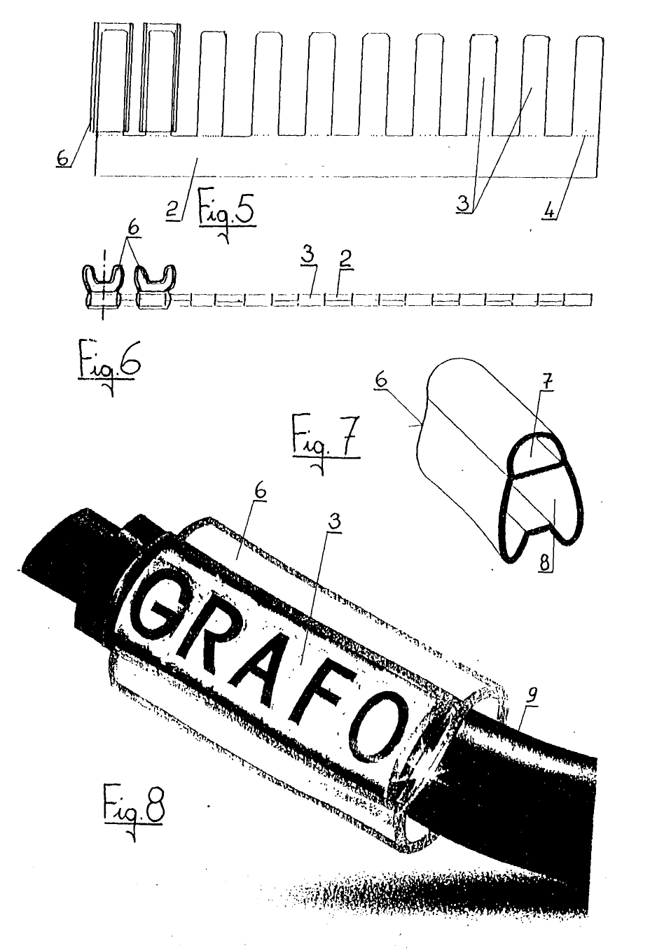

FIG. 4 shows a perspective view of the completely superimposed film illustrated in FIG. 2;

FIG. 5 shows a top view of the double thickness comb-shaped element provided with some supports for the tags;

FIG. 6 shows a side view of the comb-shaped element of double thickness illustrated in FIG. 5.

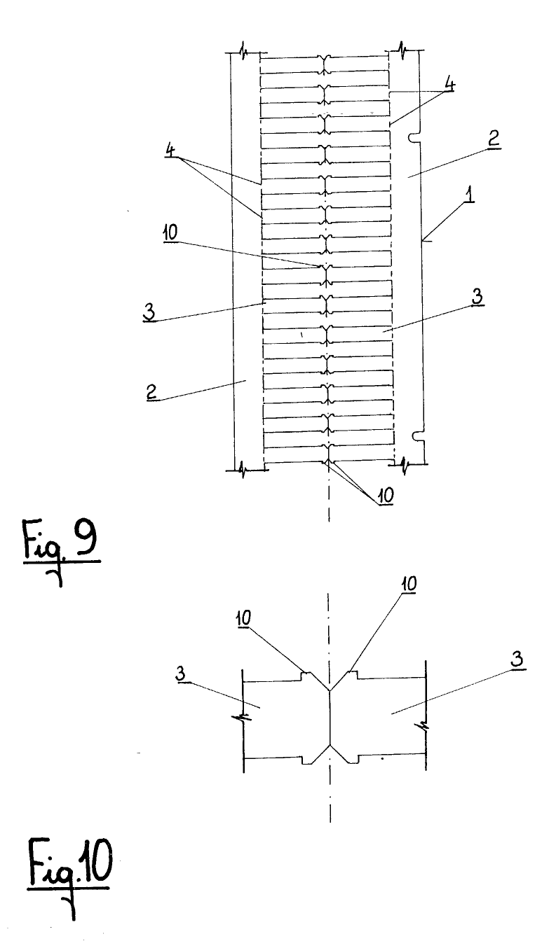

FIG. 7 shows a perspective view of an exemplified support for cable marking;

FIG. 8 shows a perspective view of an exemplified marked cable;

FIG. 9 shows a top view of the film illustrated in FIG. 1 with tags featuring arrow shapings along the folding area;

FIG. 10 shows a magnified detail of the arrow shaping illustrated in FIG. 9.

With reference to these figures, the tags are obtained from a continuous strip die-cutting from continuous calendered sheets.

The continuous strip 1 is illustrated in FIG. 1 and it is die-cut so as to obtain two lateral margins 2 interconnected by opposed tags 3 and butt jointed in the central part thus forming opposed comb-shaped elements.

The tags are attached to the lateral margins 2 by dotted pre-fracture lines 4. Other prefracture lines 5 permit the detachment of subsequent die-cutting strips.

The continuous strip is inserted in a thermal transfer label printer, so that the markings for the identification of electronic components, are printed on the inner tags of the strip as shown in FIG. 2.

The strip is then folded along the central jointing line of the tags shown in FIG. 3 until all tags 3 and lateral margins 2 are perfectly superimposed as shown in FIG. 4.

At this point, a comb-shaped configuration is achieved in which all marked tags are positioned in one direction and the supports 6, are applied on these tags; as is known, these supports 6 are featuring an upper transparent recess 7 in which to lodge the marked tag and a lower configuration 8 to secure the support 6 to the electronic instrument or component to be identified. After the support has been applied to the tag, the latter is detached from its lateral margin 2.

The identification marking is printed identically on both tag components so that the tag, after superimposition, can always be fitted in its support, irrespective of its orientation, and it can easily be handled, even by left-handed persons.

FIG. 7 shows for exemplification purposes a support 6 for the marking of a cable 9 featuring the exemplar characters “GRAFO” printed on the tag.

According to this invention, the lateral edges of the tags 3 and preferably their lateral ends feature small bulges 10 which may be of any nature but should be preferably arrow shaped to ensure stable installation of the tags in the supporting recess.

Therefore, according to this invention, a method is achieved for marking electronic components with the aid of a continuous strip with marking by a thermal transfer printer, then folded together after printing so that the printed tags can easily be handled and fitted in their supports to be fastened or directly applied on the equipment already provided with its own supports.

These new marking tags are compatible with all normal and known marking elements already produced by the Applicant and they may also be used in support or instead of the “Plotter System” series where a normal plotter is used for marking of the tags.

1) printed multiple tags of double thickness for marking electrotechnical and/or electronic elements, characterised in that:
these tags (3) are manufactured by die-cutting from a thin continuous strip (1) of calendered material, so that two lateral margins (2) are obtained by this die-cutting interconnected by opposed tags, which in turn are butted in the centre,
both opposed tags (3) are identically marked with the proper marking by a thermal transfer label printer;
the strips (1) with the marked tags (3) are then folded to create tags of double thickness and double markings on both outer surfaces;
these double thickness tags (3) will then be provided with a suitable support (6) for marking electric components after the tags have been removed from the superimposed margins (2) or are directly used on electronic components provided with their own support.

2) Printed multiple tags as described in claim 1, characterised in that the lateral edges of the tags (3) and preferably beside their ends, feature small bulges which may be of any nature, but should be preferably arrow shaped to ensure stable installation of the tags in the supporting recess (6).

3) Multiple tags as described in claim 1, characterised in that the double thickness tags, properly marked, are compatible with the marking material normally available on the market.
